(19) United States
(12) Patent Application Publication
(10) Pub. No.: US 2007/0087316 A1
(43) Pub. Date: Apr. 19, 2007

(54) System And Method For Commerce In Multimedia Books

(76) Inventors: David C. Arnold, Henniker, NH (US); Rick J. Blaisdell, Stratham, NH (US); Robert E. Mancarella, Portsmouth, NH (US)

Correspondence Address: WILMER CUTLER PICKERING HALE AND DORR LLP, 60 STATE STREET, BOSTON, MA, 02109, US

(21) Appl. No.: 11/279,212

(22) Filed: Apr. 10, 2006

Related U.S. Application Data
(60) Provisional application No. 60/726,541, filed on Oct. 14, 2005.

(51) Int. Cl. G09B 5/00

(52) U.S. Cl. 434/317

(57) ABSTRACT

A computer-implemented method involving receiving a plurality of multimedia books, each multimedia book including: a plurality of pages, each page having a text description and belonging to a chapter, at least one of the pages including a playable digital medium; a searchable table of contents; and a searchable index. The method also involves: including information about the plurality of multimedia books in an online electronic store; enabling a customer of the online electronic store to view the information about the plurality of multimedia books and to purchase access to a selected one or more of the plurality of multimedia books; and after the customer has purchased access to the selected one or more of the plurality of multimedia books, enabling the customer to search and view the selected one or more of the plurality of multimedia books using a web browser.

### RELATED APPLICATION

This application claims priority to U.S. patent application Ser. No. 60/726,541, filed on Oct. 14, 2005.

### BACKGROUND OF THE INVENTION

1. Field of the Invention

This invention relates generally to multimedia books and in particular to the creation of multimedia books and multimedia book libraries.

2. Description of the Related Art

Various forms of storing and disseminating knowledge have been developed and utilized over time. Among these forms, traditional books containing text and graphics have been dominant for millennia. However, despite their enormous popularity and longevity, traditional books have their limitations. First, text and graphics are static media, and traditional books cannot handle dynamic media, such as video and audio. Second, traditional books are cumbersome to update because updates must typically wait for the republication of the entire book as a new edition, which is often occurs only infrequently. Third, traditional books are expensive to produce, ship, and market.

Some of the limitations of traditional books have been addressed by the development of electronic books, or e-books, which essentially consist of traditional book content transformed into a digital format suitable for display and storage by a computer or hand-held device such as a personal digital assistant. E-books are not printed but rather stored in a digital format by a computer. Once an author/publisher has produced an e-book, it can be copied at no additional cost. Moreover, e-books can be updated without the need to republish an entire edition, and the newest version is easily downloaded over the Internet.

However, e-books also have some disadvantages. Since e-books are usually traditional books that have been transferred into a digital format, they are usually limited to text and static graphics. In addition, in order to view an e-book on a particular device, a copy of the e-book must reside on that device. Furthermore, to update an e-book, the user needs to download the entire book since incremental updates are typically not available.

### SUMMARY OF THE INVENTION

In general, in one aspect, the invention features a computer-implemented method involving receiving a plurality of multimedia books, each multimedia book comprising: a plurality of pages, each page belonging to a corresponding chapter of a plurality of chapters, each chapter having a chapter name, each page further having a text description, at least one of the plurality of pages including a playable digital medium; a searchable table of contents whose entries comprise the chapter names; and a searchable index, wherein each entry in the searchable index is associated with pointers to one or more of the plurality of pages having at least one of a page title, a description, a keyword, or a chapter title that includes the index entry. The method also involves: including information about the plurality of multimedia books in an online electronic store; enabling a customer of the online electronic store to view the information about the plurality of multimedia books and to purchase access to a selected one or more of the plurality of multimedia books; and after the customer has purchased access to the selected one or more of the plurality of multimedia books, enabling the customer to search and view the selected one or more of the plurality of multimedia books using a web browser.

### BRIEF DESCRIPTION OF THE DRAWINGS

FIG. 1 is a functional block diagram depicting components of a vBook system.

FIG. 2 is a functional block diagram of a vBook application.

FIG. 3 is a screenshot of a vBook viewer running within a vBook application.

FIG. 4 is a screenshot of vBook authoring tools.

FIG. 5 is page of a spreadsheet used to create a vBook.

FIG. 6 is a functional block diagram of a vBook library and vBook stores.

FIG. 7 is a screenshot of a vBook library.

FIG. 8 is a screenshot of search results from a vBook library search.

FIG. 9 is a flow diagram showing the steps involved in purchasing access to a vBook.

FIG. 10 is a screen shot of a vBook store.

FIG. 11 is a screenshot of a vBook store order summary.

### DETAILED DESCRIPTION

The VBook

A vBook is a “book” of multimedia “pages” that, in addition to the usual text and graphics, can also include video, audio, slide shows, the output of computer-aided design (CAD) programs, or any medium in digital format that can be “played back” by a user. When a user views a page in a vBook, he sees the text and graphics, as well as a window embedded within a displayed vBook page for viewing additional digital media associated with the page. The embedded window is generated by a third party player that corresponds to the format of the additional digital medium. The player is invoked automatically by the vBook when the user opens the vBook page on which the medium appears. For example, if a vBook page includes video, the vBook invokes a video player such as Windows Media Player, which opens a window that includes playback controls and the video output; if a vBook page includes a slide show, the vBook invokes a slide show viewer such as PowerPoint Viewer, and the embedded window displays slide show controls and the slide itself.

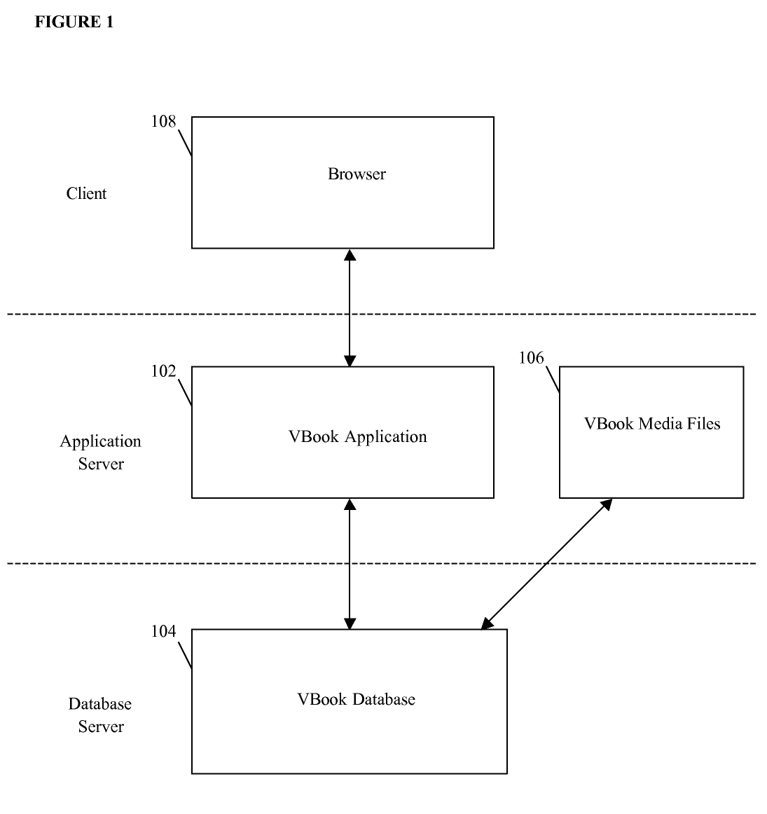

The main components of a vBook, illustrated in FIG. 1, are vBook application 102, which runs on an application server, vBook database 104, which runs on a database server, and vBook media files 106, which are usually stored on an application server, though not necessarily the same server that stores vBook application 102. A user views and navigates through a vBook on a client computer by using a browser 108 that points to vBook application 102, which in turn communicates with vBook database 104 and vBook media files 106. Browser 108 runs on a personal computer having access to the Internet, or on mobile communications device.

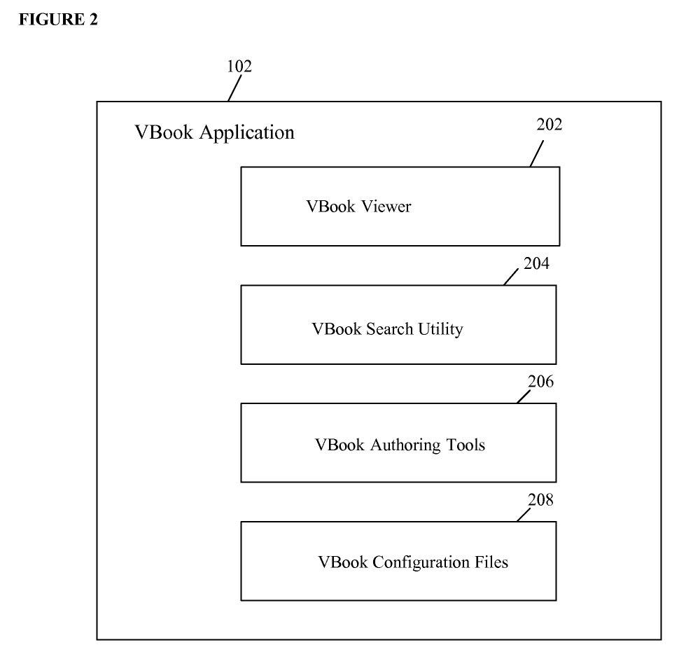

FIG. 2 shows vBook application 102, which includes the following components or software modules: vBook viewer, 202, vBook search utility 204, vBook authoring tools 206, and vBook configuration files 208. VBook viewer 202 gathers vBook page content information from vBook database 104 and displays vBook pages within client browser 108. VBook search utility 204, described in more detail below, performs natural language searches of the vBook, and returns the search results to browser 108. VBook authoring tools 206 enable authors to create new vBooks and edit existing vBooks. The authoring process is described below. Configuration files 208 include the name/location of vBook database 104, and username and password information for allowing the application server to communicate with the database server via a secure connection.

VBook database 104 is a SQL database residing on a database server that contains the structure and the text content of a vBook. It also contains pointers to any non-textual content belonging to the vBook. This non-textual content is stored in vBook media files 106 that contain images, audio, video, and third party digital formats, such as DWF CAD files and PowerPoint slides. These are held in a secure directory on a server that is typically the application server on which vBook application 102 runs.

When a user selects a vBook page from browser 108, vBook application 102 retrieves the page content from vBook database 104, which in turn retrieves any required any needed non-textual media from vBook media files 106. VBook application 102 then passes the page to browser 108, which displays the page on the client. The communication between browser 108 and vBook application 102 is via the Internet, either via a fixed connection or a wireless access network. The communication between vBook application 102, vBook database 104, and vBook media files 106 is via data access networks, including the Internet and private networks.

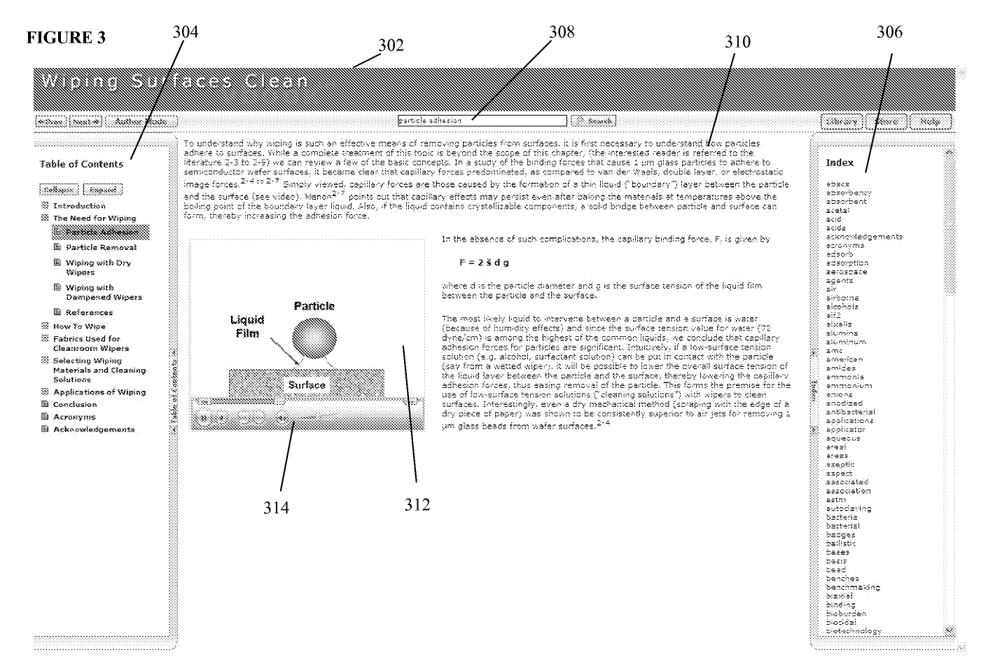

FIG. 3 is a screen shot of vBook application 102 running in browser window 302 on a PC, showing table of contents 304, index 306, and natural language search bar 308. Page content 310 is displayed in the middle of the window. Within content display area 310, text, graphics, audio, video 312, and other digital media may be displayed. VCR-type controls 314 of the media player (e.g., Windows Media Player, or Real Player) enable the user to control playback of audio and video that may be embedded within a page. The layout of table of contents 304, index 306, search bar 308, and display area 310 is a matter of design convention, but it is desirable to make it consistent, both throughout an individual vBook, and among different vBooks. With a consistent layout, vBook users can become very familiar with a single vBook interface and need not learn a different interface for each vBook.

A vBook user may choose to traverse the pages of a vBook in the order in which they appear in the table of contents, like a reader of a conventional book reading from front to back. More often, however, a user will want to locate something specific within the vBook. vBooks provide three ways of helping a user find what he is looking for.

First, like a conventional book, the pages of a vBook are organized into chapters. VBooks have a hierarchical structure, with chapters having sub-chapters, sub-sub-chapters, and so on. Table of contents 304 lists the chapter headings, each of which expands when clicked on to show the next level down, either sub-chapters or individual pages. Clicking on a page title within the table of contents causes the application to display the corresponding page, and automatically start playing any media embedded within the page. A feature of the vBook application allows the user to set the viewer not to play the media until the user takes further action.

Second, a vBook has alphabetized index 306 having entries, each of which is associated with a list of corresponding pages in the vBook. The index is described in detail below. When the application clicks on an index entry, the entry expands to show a list of pages corresponding to that entry, and the application can select an individual page for viewing.

Third, a vBook has natural language search function 308 that enables a user to enter a word or a question, and search the entire vBook. The natural language search function uses techniques that are well known in the fields of knowledge management and search, including word or phrase matching, searching of misspellings, synonyms, word stemming, and using various measures, such as page view rates to weight or rank the results. When the user enters a search term, the vBook returns a list of search results with chapter, subchapter, or individual page names. Clicking on chapter or subchapter names causes them to expand to show their constituent pages; clicking on a page name displays the page.

Creating a vBook

When an author wishes to create a new vBook, he sends a request to a vBook hosting facility provider. Usually, the hosting facility provider is the same entity that hosts the vBook application server and vBook database server. The vBook hosting facility provider uses a script to copy a clean version of a vBook application to a vBook application server, creating a new instance of the vBook application, identified by the vBook name provided by the author. The script then creates a clean copy of a vBook database with the corresponding vBook name. The clean copy includes all required tables and structure for a vBook, with each record being blank. The script also sets up a vBook configuration file with master user and password information and network location information, enabling the vBook application to communicate with the vBook database. Authors create vBooks by using special-purpose authoring tools 206 that are a part of vBook application 102. Authoring tools 206 are designed to let authors create content easily, quickly, and inexpensively in a range of media formats. The author uses authoring tools 206 within client browser window 108, with the tools actually running on the application server. Authoring tools 206 upload the entered content to vBook database 104 and media files 106.

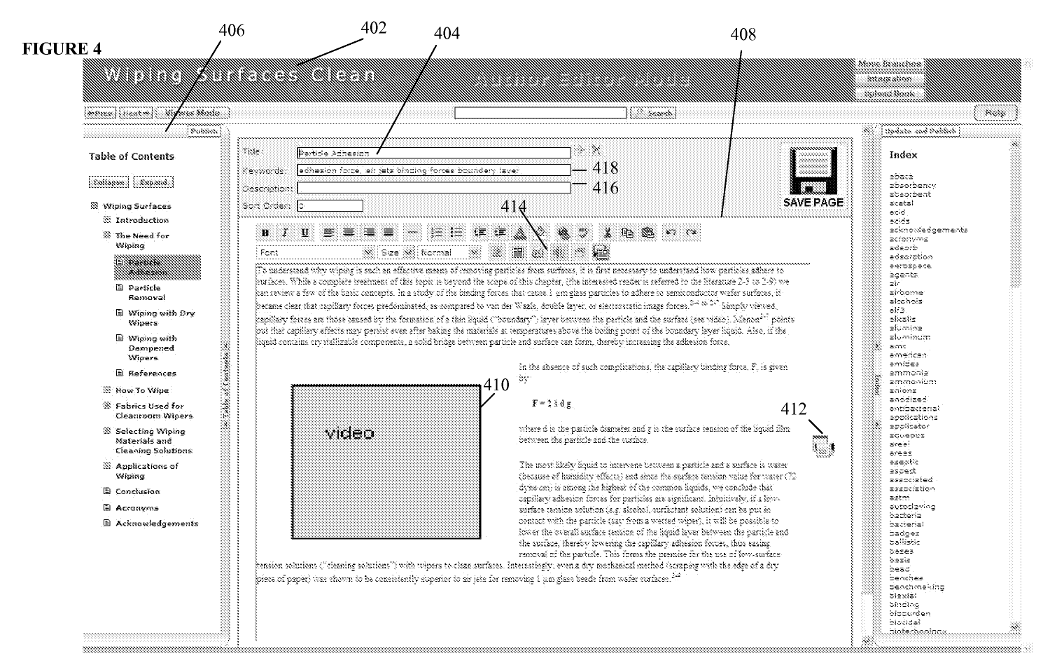

FIG. 4 is a screen shot of authoring tools 206 running in a client browser window 402. The author enters the page title in box 404, and drags the page title into its desired location within the hierarchical table of contents in window 406, thus creating the hierarchical vBook table of contents 304 (FIG. 3) on the fly. The author enters the page content directly into main content window 408, which serves as a multimedia WYSIWYG (What You See Is What You Get) editor.

To enter text, the author either types directly into content window 408, or imports a text file. To add a video to a page, the author creates a video window 410, and then selects whether the input is screen capture from a PC application, input from a video camera, an external video source, or a local file. To import video from a video camera or external video source, such as a DVD player, the author clicks on camera icon 412; to import a local file, including files created by screen capture from an application, the author selects toolbar icon 414. When video input is complete, a media file creation tool resizes the media to the appropriate resolution and size, and formats the recorded data into a selected media format, such as MPEG, WMV, AVI, MOV. Author tools 206 upload the video to vBook database 104, which in turn places the video in vBook media files 106 and retains a pointer to the video file.

To complete the vBook page, the author generates one or more keywords to describe the page, and enters the keywords into box 416. He also adds a brief page description of the page in box 418, and specifies a subject category for the vBook. The subject category is used to help organize vBook searches in vBook libraries, as described below. VBook authoring tools 206 in conjunction with vBook database 104 are designed to generate the html description of the vBook page, including the html that embeds the media into the vBook page. The author requires no html knowledge for this purpose.

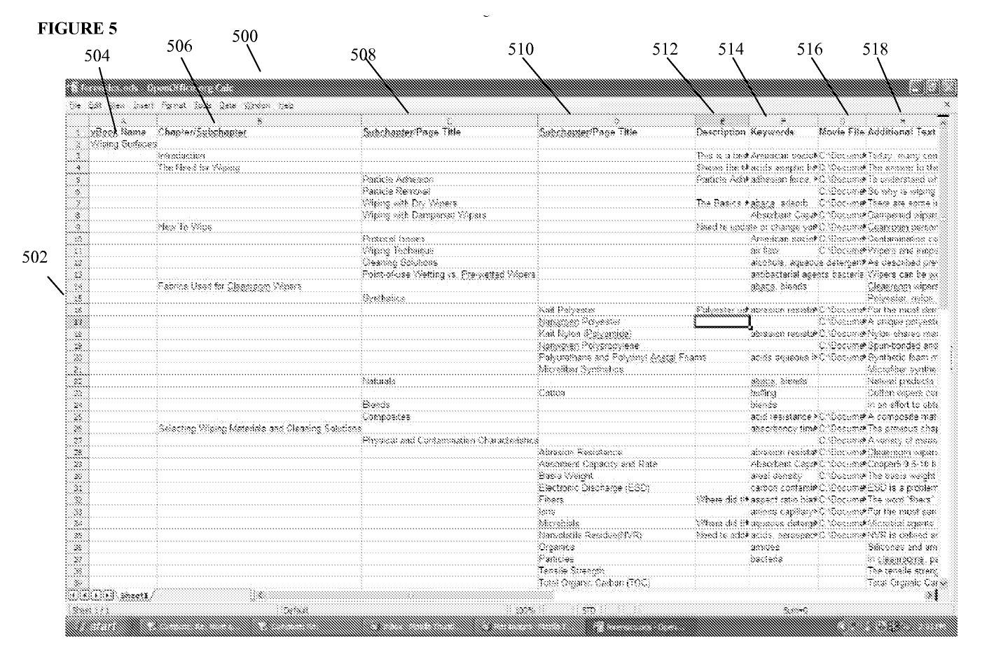

Rather than building a vBook directly within authoring tools 206, an author can use a standard spreadsheet to create the vBook structure and enter text for a vBook pages. This offers a convenient way to enter and edit the structure of a vBook, especially when the vBook is large and has an elaborate structure. FIG. 5 shows a spreadsheet 500, each row of which, such as row 502, represents one page of a vBook. The title of the vBook, in this case “Wiping Surfaces,” is entered in column 504. For example, row 502 describes a vBook page within the chapter (column 506) entitled “Fabrics Used for Cleanroom Wipers,” subchapter (column 508) entitled “Synthetics,” and page title (column 510) “Knit Polyester.” The page description “Polyester uses.” appears in column 512, the keyword “abrasion resistance” in column 514, the name and location of the movie file in column 516, and page text in column 518. When the spreadsheet is complete, the author imports the vBook spreadsheet into authoring tools 206 as a comma separated values (CSV) file. Authoring tools 206 then build the vBook from the imported data, and transfer it to vBook database 104.

A key feature of authoring tools 206 is their ability to generate vBook index 306 automatically. In the default mode, the entries in index 306 include all the keywords and any of the words that appear within the table of contents, page titles, page text contents, and page descriptions, excluding common words, such as prepositions and common verbs. To control the size of the index, authors can opt to limit index entries to a subset of the above sources, for example excluding page text content as a source of index entries.

Each index entry is associated with a set of links that point to vBook pages that correspond to the index entry. For example, if the index entry corresponds to one of the keywords in the vBook, the links associated with that index entry point to all the pages having that word as one of their keywords. If the index entry is derived from the text content of one or more pages, the associated links point to all the pages containing the word, as well as pages having the word in their titles, descriptions, or chapter headings. In order to help authors improve the relevance of index entry lists, especially if the lists are lengthy, the authoring tools enable pruning of the list of links. For example, if an index entry has links to both page titles and to text within a page, the author can opt to limit the list of links to those that point only to pages having that index entry in their titles.

VBooks are particularly useful for conveying information that lends itself to being shown rather than explained as text or static graphics. Often, answers to a “how do I . . . ?” question are especially effective when presented in a vBook. Subjects that are well suited to such “show me” and “how to” approaches include: product manuals, especially for complex items such as cars, software, or electronic consumer products; home improvement projects; cooking; and skills training, such as learning a foreign language or playing a musical instrument. In general, users pay to gain access to vBooks, but certain vBooks may be free of charge to the user. A seller of goods or services can provide free vBook access to a customer who has already purchased a related product or service. Providers of goods and services may also use vBooks as marketing and sales tools by offering them to users at no charge.

The VBook Library

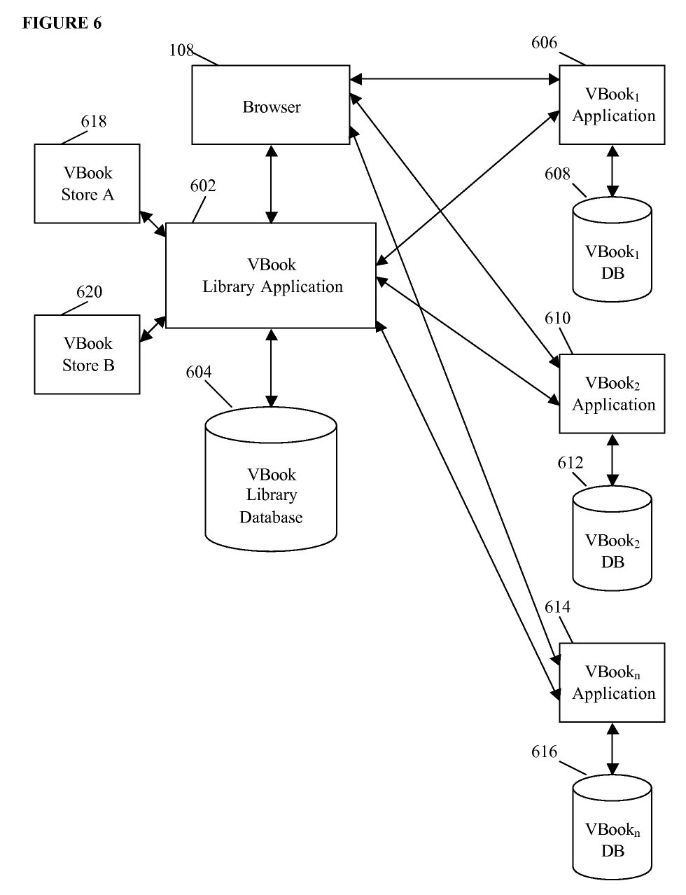

A user accesses his collection of vBooks via his personal vBook library. The user can access his library from any Internet- connected machine by pointing his browser to his library application URL and entering his vBook library username and password. FIG. 6 shows the main components of a vBook library and its relationship to individual vBooks. The vBook library includes vBook library application 602, which runs on an application server, typically a server that is different from the server running the individual vBook applications and vBook library database 604, an SQL database running on a database server. VBook library application 602 and individual vBook applications, 606, 610, and 614 communicate with each other via the Internet or via another data network.

VBook library database 604 contains the records of which vBooks the user currently has access to, the subject category of each vBook, and cover information 707 to be displayed in the main library window. As indicated above, vBook page content is not retained by vBook library database 604, but resides within the respective databases DB₁-DBₙ (608, 612, 616) associated with the individual vBooks that are in the library.

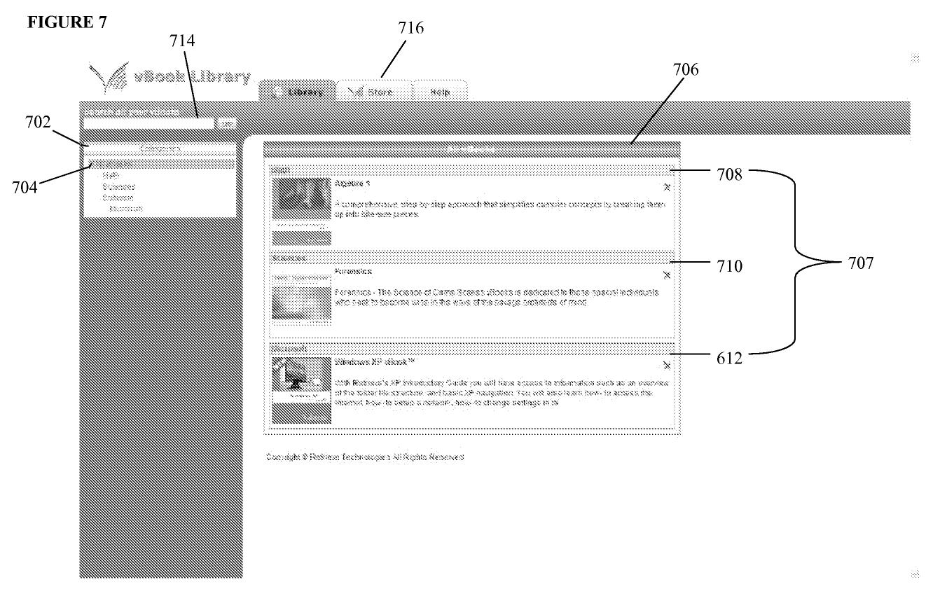

FIG. 7 shows a screen shot of the main screen of the library application. Category window 702 displays the subject categories of books within the user's library. The user selects a category for viewing or for searching by clicking within the window. In the screen shot shown in FIG. 7, the user has selected “All vBooks” (704). VBook information window 706 displays the category 704 and cover information 707 of vBooks corresponding to the user's category selection in window 702, in this case showing cover information for three vBooks: Algebra I 708, Forensics 710, and Windows XP vBook 712.

The vBook library application allows a user to search his entire library of vBooks or a selectable subset thereof in a single search. The user can search the entire library, by selecting “All vBooks” in category window 602, or can limit the search to specific categories, by selecting those categories in the category window. The user can also select categories and add individual vBooks to that selection. In order to search a library, the user enters a search term in search box 714 and selects “Retrieve”. In response, the library application issues a web services request that comprises the search criteria to all the vBooks to be searched.

Upon receiving the search request from the library application, each vBook application 606, 610, 614 performs its own natural language search of its respective vBook database 608, 612, and 616, and returns search results to the library application in the form of a list of pages ranked by relevance. The relevance ranking is performed by standard knowledge management techniques, taking into account such information as the number of times the word appears on the page and the past view rate of the page. The library application then displays the lists of search results returned by each searched vBook in order of the relevance ranking.

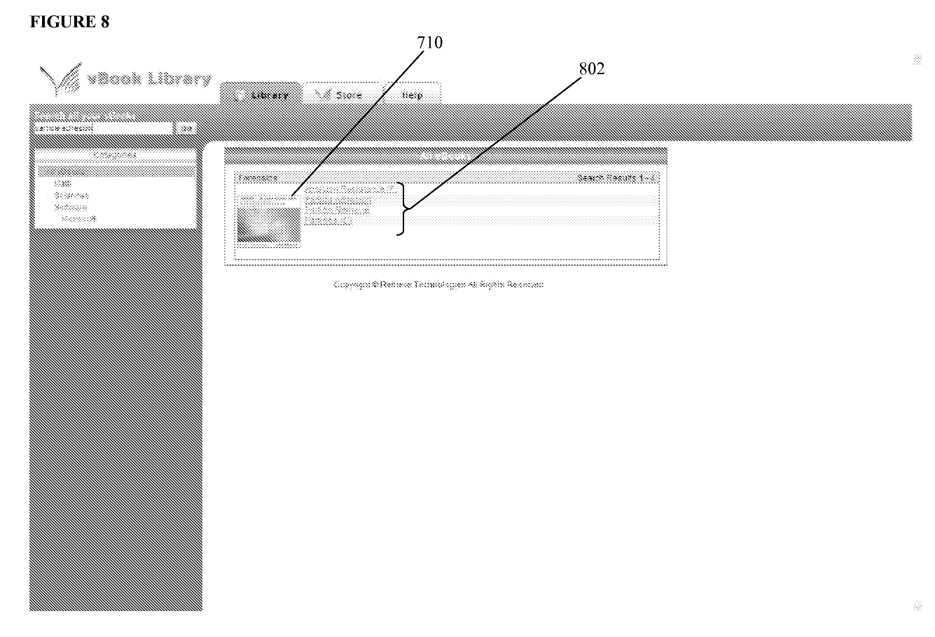

FIG. 8 is a screen shot of the library application showing search results 802 for the search term “particle adhesion” resulting from a search of all the vBooks in the library shown in FIG. 7. In this case, only the vBook entitled Forensics 710 returned matching pages, and the pages are listed in the book window, ranked by relevance. As shown in FIG. 8, the Forensics vBook page entitled Abrasion Resistance has the highest relevance. If the user clicks on this page link, the library application passes the users' credentials (user name and password) on to the Forensics vBook application. The Forensics vBook then checks the Forensics vBook database to see if the user has access to the book. If the user's access is authorized (i.e., his page view count is not reached nor his expiry date reached), the selected page opens within the Forensic vBook's application. The user does not need to traverse any intermediate screens, such as the title page of the vBook or a table of vBook contents, in order to reach his desired content.

If multiple vBooks return search results, results lists appear for each vBook. Alternatively, the user can select an option that combines the results from different vBooks into a single list ranked by relevance.

When a new vBook is added to a vBook library, the vBook library application 602 receives links to the new vBook application, and automatically updates its database. Once added to the library, the new vBook will be included in subsequent searches, as discussed in more detail below.

VBook Business Models

The following is a description of one business model according to which publishers and authors charge users for access to vBooks.

According to this model, a customer purchases a vBook from an online store. Once a user completes a purchase, he acquires access to a vBook. To achieve this, the vBook store communicates information about the purchase to the user's vBook library 602, which adds the newly acquired vBook to the user's vBook library as described in detail below. VBook library application 602 can be configured to receive purchase information from any type of online, electronically based commerce system, including the systems used by major online retailers, such as Amazon.com.

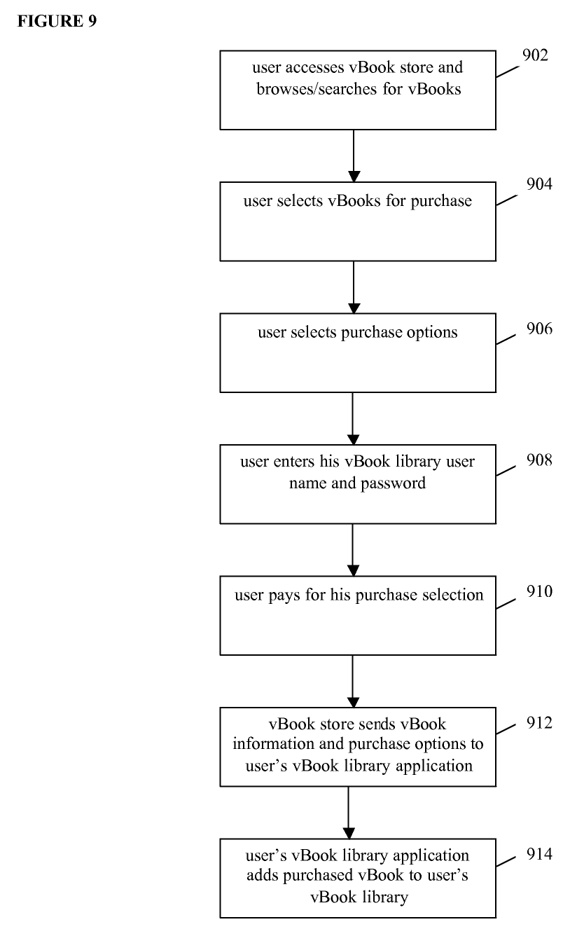

FIG. 9 is a flow diagram showing the steps that take place when a user purchases access to a vBook. The process starts when the user access a vBook store (step 902) by selecting “Store” tab 716 (see FIG. 7) from the vBook library application 602, using browser 108. Library application 602 then connects the user to the vBook store. A user who purchases books from more than one store has the option to have multiple store tabs appear on his library screen, each providing a link to one of the user's preferred vBook stores. For example, when the user has two preferred stores, tabs for “vBook Store A” and “vBook Store B” (not shown) connect the user via vBook library 602 to vBook Store A (618) or to vBook Store B (620) respectively. Alternatively, a user can point browser 108 directly to an electronic online store, bypassing the vBook library.

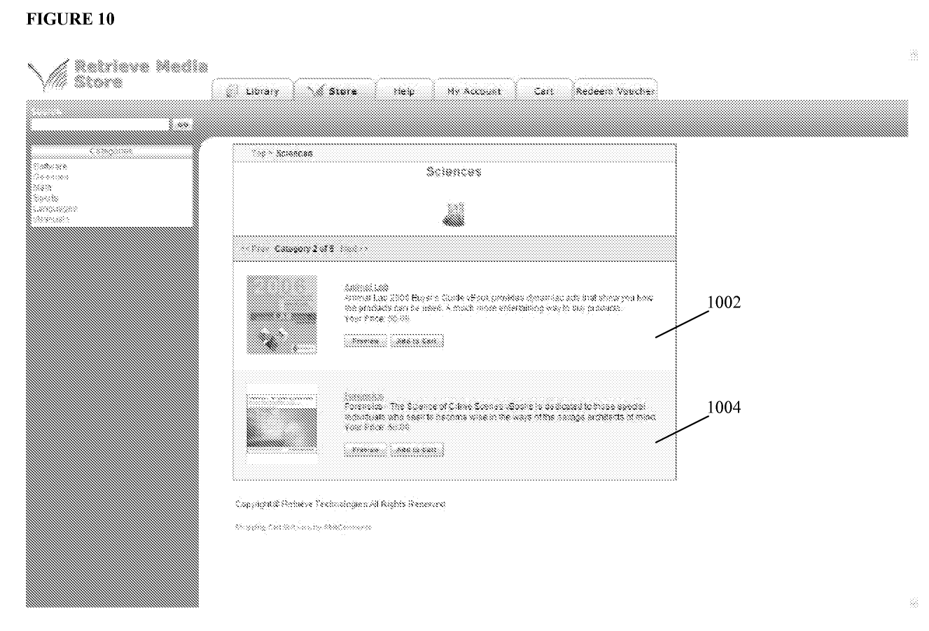

Once he is at the online vBook store, the user browses and/or searches for a vBook using the search tools provided by the online store. For example, if a user searches a vBook store for vBooks in the “Sciences” category, the store would return a list of science vBooks. FIG. 10 is a screen shot of an online store showing an illustrative vBook store's response to such a request. Each vBook is shown with cover information 1002, 1004, consisting of a cover illustration and a few lines of text that includes pricing information.

When the user is ready to purchase access to a vBook, he adds the vBook to his cart, and then selects “checkout” (step 904). The online store then presents the user with various purchase options (step 906). One option offers the user a limited number of page views over a limited time. Another option offers the user an unlimited number of page views over a limited time. Purchase option refinements offer options to provide access to certain pages of a vBook only, an arrangement that may be appropriate when purchasing access to a large reference work.

The store then requests the users' vBook library user name and password (step 908). This identifies the user's vBook library to the store, allowing the store to ensure that it gives access to the purchased book to the correct vBook library. This step is analogous to obtaining the customer's shipping address. Note, the vBook library user name need not be the same as the user's vBook store user name.

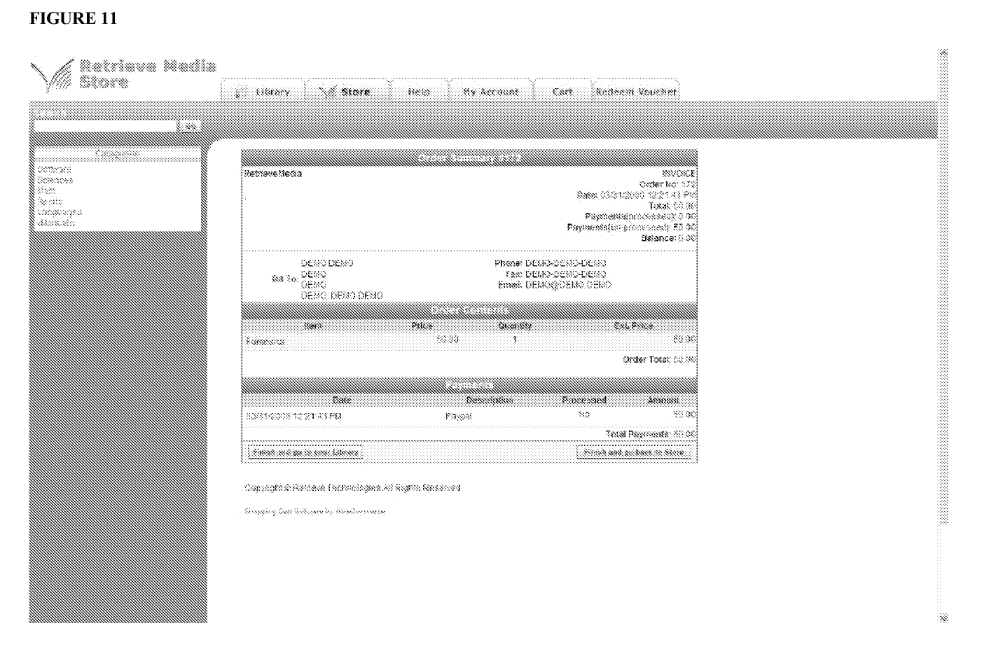

When the customer has selected his purchase options and provided his vBook user name and password, he pays the vBook store for his vBook selection (step 910), and then receives an order summary and confirmation. FIG. 11 shows a screen shot of the customer's order summary.

As indicated above, a vBook author, publisher, or other entity may wish to provide a user access to a vBook without charging the user. In such cases, the vBook provider and vBook store can implement a free transaction by requiring that the user enter a specific “free purchase” code he has been provided with by the vBook author, publisher, or other entity. After validating the code, the vBook store grants access just as if the vBook had been purchased.

Once the purchase is completed, the online store makes a connection to the user's vBook library application 602 via an http post or via web services using the user's vBook username and password. It then pushes to the vBook library the order identification number, the URL for the purchased vBook, and the URL for the purchased vBook's cover information 707 (step 912).

The vBook store also sends the user's vBook library application a subject matter category ID of the purchased vBook. The category ID corresponds to a subject matter category within a master subject category list stored within the vBook library application. For example, Forensics vBook 1004 (FIG. 10) has a subject category ID corresponding to the Science category. The subject matter category ID of the purchased vBook enables the vBook library to place the vBook in the appropriate place within the subject category hierarchy, so that the vBook will appear in the vBook library under the appropriate categories.

In addition, the vBook store pushes to the vBook library the vBook purchase options selected by the user. This includes the number of page views purchased and the expiration date of the purchased page views.

The vBook library application uses the information it receives from the vBook store to add the purchased vBook into the user's vBook library (step 914) as follows. The vBook library adds the URL, the subject matter category, and cover information of the purchased vBook to the vBook library database. In addition, the vBook library forwards the user's vBook library username and password information together with his purchase options to vBook application corresponding to the purchased vBook, which in turn stores it in the purchased vBook's database. Alternatively, the vBook library stores the vBook purchase options in the vBook library database instead of in the individual vBook databases.

Apart from cover information 607 and subject category ID, none of the content of the purchased vBook is actually transferred to the library application. Instead, the vBook content, including the vBook application and the vBook database remain on their application servers and database servers, respectively. This arrangement ensures that there is only one, “master” copy of a vBook at any one time. An advantage of this arrangement is that any changes or updates to the vBook become instantly available to all of the vBook's users.

Once a book has been added to the library, the vBook cover information 607 appears within the library screen 606, and the user can access the vBook directly by selecting it from the library screen, or by including it within a search.

Each vBook keeps track of each user's access status. When the user wishes to view the contents of a vBook page, the vBook application checks the vBook database to determine whether the user's access to the vBook is active, i.e., he has not reached an applicable page view limit or passed an access expiry date. If the user's access is active, the vBook application passes the page content to the user's browser window 108 where the user can view the page. If the user has purchased a limited number of page views, the vBook application decrements the number or remaining page views, and the updated number of remaining page views is stored in the vBook database.

When the user reaches his page view limit or his expiry date, the vBook application notifies the user and presents options to purchase additional access. If the user does not purchase additional access, the vBook application does not display the page content. While the user no longer has access to a vBook, the links to the lapsed vBook remain in the vBook library, but the page link will be “greyed out.” This allows users to remain aware of vBook content they previously had access to, and to decide, based on the vBook cover information and vBook page titles, whether or not to pay for renewed access.

Although the library links to a vBook are not automatically removed when the user's access to a vBook expires, the user can request that they be removed. This allows the user to control the number of inactive links that are returned in searches, or selectively remove inactive books from the library screen. This is especially useful for vBooks that are unlikely ever to be of interest to the user again.

The functions described above may be implemented as a set of program instructions that are stored in a computer readable memory of a computer connected to a network. The instructions are executed on one or more processors of the computer. Some or all of the functions described may be implemented in hardware.

Other embodiments are within the scope of the following claims.

What is claimed is:

1. A computer-implemented method comprising:
receiving a plurality of multimedia books, each multimedia book comprising:
a plurality of pages, each page belonging to a corresponding chapter of a plurality of chapters, each chapter having a chapter name, each page further having a text description, at least one of the plurality of pages including a playable digital medium;
a searchable table of contents whose entries comprise the chapter names; and
a searchable index, wherein each entry in the searchable index is associated with pointers to one or more of the plurality of pages having at least one of a page title, a description, a keyword, or a chapter title that includes the index entry; and
including information about the plurality of multimedia books in an online electronic store;
enabling a customer of the online electronic store to view the information about the plurality of multimedia books and to purchase access to a selected one or more of the plurality of multimedia books; and
after the customer has purchased access to the selected one or more of the plurality of multimedia books, enabling the customer to search and view the selected one or more of the plurality of multimedia books using a web browser.

2. The method of claim 1, wherein the information about the plurality of multimedia books is included in a plurality of online electronic stores.

3. The method of claim 1, wherein, after the customer has purchased access to the selected one or more of the plurality of multimedia books, linking the selected one or more of the plurality of multimedia books to a searchable library of multimedia books such that searching the library using a search term returns a list of pages that includes pages from the selected one or more of the plurality of multimedia books, and wherein each page of the list of pages is associated with a table of contents entry or an index entry that is responsive to the search term.

4. The method of claim 1, wherein purchasing access to the selected one or more of the multimedia books enables the customer to access a predetermined number of pages of the selected one or more of the plurality of multimedia books.

5. The method of claim 1, wherein purchasing access to the selected one or more of the multimedia books enables the customer to access pages of the selected one or more of the plurality of multimedia books for a predetermined period of time.

6. The method of claim 5, further comprising:
after the predetermined period of time has elapsed, terminating the customer's access to the pages of the selected one or more of the multimedia books; and
enabling the customer to continue to view links to pages from the expired multimedia books that are responsive to the search term.
